(19) United States
(12) Patent Application Publication
(10) Pub. No.: US 2026/0110567 A1
(43) Pub. Date: Apr. 23, 2026

(54) SYSTEM AND ROBOTIC ASSEMBLY FOR WEIGHT MEASUREMENT OF A SUPPORTED LOAD

(71) Applicant: TECHTREX INC., Etobicoke (CA)

(72) Inventors: Charles LEE, Etobicoke (CA); Seon-Kyoo LEE, Etobicoke (CA); Huaping ZHAO, Qingdao City (CN)

(21) Appl. No.: 19/152,922

(22) PCT Filed: Feb. 27, 2024
(86) PCT No.: PCT/CA2024/050237

§ 371 Date: Jul. 31, 2025

Related U.S. Application Data
(60) Provisional application No. 63/494,122, filed on Apr. 4, 2023.

(51) Int. Cl. G01G 19/18; B25J 9/16

(52) U.S. Cl. CPC G01G 19/18; B25J 9/1633

(57) ABSTRACT

There is provided a robotic assembly and system for weight measurement of a supported load. The system including: an assembly-side interface plate connectable to a robotic assembly; a load-side interface plate connectable to a load support, the load support to receive a load; hinge assemblies located intermediate the assembly-side interface plate and the load-side interface plate to permit tilting of the load-side interface plate relative to the assembly-side interface plate along a tilting axis; and a force sensor located intermediate the assembly-side interface plate and the load-side interface plate on the assembly-side interface plate or the load-side interface plate, the force sensor located to a side of the tilting axis, the force sensor engageable to convert a force acting on the force sensor to an electrical signal when the load support supports the load.

### TECHNICAL FIELD

The following generally relates to robotic manipulators, and more specifically, to a system and robotic assembly for weight measurement of a supported load.

### BACKGROUND

Robotic arms are generally useful to automate various traditionally manual processes. With a grabber installed on a tip of the robotic arm, it is possible to mimic the manual activities performable by a person for a diverse range of applications; for example, from lifting heavy loads to making small movements of light weight objects. In some cases, it may be beneficial to make measurements of the lifted loads, which has a number of substantial challenges.

### SUMMARY

In an aspect, there is provided a system for weight measurement of a supported load, the system comprising: an assembly-side interface plate connectable to a robotic assembly; a load-side interface plate connectable to a load support, the load support to receive a load; hinge assemblies located intermediate the assembly-side interface plate and the load-side interface plate to permit tilting of the load-side interface plate relative to the assembly-side interface plate along a tilting axis; and a force sensor located intermediate the assembly-side interface plate and the load-side interface plate on the assembly-side interface plate or the load-side interface plate, the force sensor located to a side of the tilting axis, the force sensor engageable to convert a force acting on the force sensor to an electrical signal when the load support supports the load.

In a particular case of the system, the system further comprising a movement limiter located intermediate the assembly-side interface plate and the load-side interface plate on the assembly-side interface plate or the load-side interface plate, the movement limiter located to a side of the tilting axis opposite the force sensor, the movement limiter arresting further tilting after disengagement of the force sensor.

In another case of the system, the movement limiter defining a gap between an end of the movement limiter and the opposing assembly-side interface plate or the opposing load-side interface plate.

In yet another case of the system, the robotic assembly comprises a robotic arm.

In yet another case of the system, the load support comprises a grasping assembly.

In yet another case of the system, a combined center of gravity for the load support and the load-side interface plate is located along a common plane with the tilting axis such that the assembly-side interface plate and the load-side interface plate are substantially parallel with the load support is unloaded.

In yet another case of the system, the force sensor is located on a side of the tiling axis opposite the load support, and wherein the force sensor measures extension forces acting on the force sensor.

In yet another case of the system, the force sensor is located on a side of the tiling axis proximate the load support, and wherein the force sensor measures compression forces acting on the force sensor.

In yet another case of the system, the force sensor communicates with conversion circuitry to convert the electronic signal to a force measurement, the force measurement based on a calibration associating the electronic signal with a corresponding weight.

In another aspect, there is provided a robotic assembly comprising: a robotic arm; an assembly-side interface plate connectable to the robotic arm; a load-side interface plate connectable to a load support, the load support comprising a grabber to grasp a load; hinge assemblies located intermediate the assembly-side interface plate and the load-side interface plate to permit tilting of the load-side interface plate relative to the assembly-side interface plate along a tilting axis; and a force sensor located intermediate the assembly-side interface plate and the load-side interface plate on the assembly-side interface plate or the load-side interface plate, the force sensor located to a side of the tilting axis, the force sensor engageable to convert a force acting on the force sensor to an electrical signal when the load support supports the load.

In another case of the robotic assembly, the robotic assembly further comprising a movement limiter located intermediate the assembly-side interface plate and the load-side interface plate on the assembly-side interface plate or the load-side interface plate, the movement limiter located to a side of the tilting axis opposite the force sensor, the movement limiter arresting further tilting after disengagement of the force sensor.

In yet another case of the robotic assembly, the movement limiter defining a gap between an end of the movement limiter and the opposing assembly-side interface plate or the opposing load-side interface plate.

In yet another case of the robotic assembly, the robotic assembly comprises a robotic arm.

In yet another case of the robotic assembly, a combined center of gravity for the load support and the load-side interface plate is located along a common plane with the tilting axis such that the assembly-side interface plate and the load-side interface plate are substantially parallel with the load support is unloaded.

In yet another case of the robotic assembly, the force sensor is located on a side of the tiling axis opposite the load support, and wherein the force sensor measures extension forces acting on the force sensor.

In yet another case of the robotic assembly, the force sensor is located on a side of the tiling axis proximate the load support, and wherein the force sensor measures compression forces acting on the force sensor.

In yet another case of the robotic assembly, the force sensor communicates with conversion circuitry to convert the electronic signal to a force measurement, the force measurement based on a calibration associating the electronic signal with a corresponding weight.

### BRIEF DESCRIPTION OF THE DRAWINGS

The features of the invention will become more apparent in the following detailed description in which reference is made to the appended drawings wherein:

FIG. 1 illustrates a front elevation view of a system for weight measurement of a supported load;

FIG. 2 illustrates a left-side elevation view of the system of FIG. 1;

FIG. 3 illustrates a right-side elevation view of the system of FIG. 1;

FIG. 4 illustrates a top view of the system of FIG. 1;

FIG. 5 illustrates a bottom view of the system of FIG. 1;

FIG. 6 illustrates a front perspective view of the system of FIG. 1;

FIG. 7 illustrates a rear perspective view of the system of FIG. 1;

FIG. 8 illustrates a bottom perspective view of the system of FIG. 1; and

FIG. 9 illustrates an exemplary operating environment for the system of FIG. 1.

### DETAILED DESCRIPTION

Embodiments will now be described with reference to the figures. For simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative”or “exemplifying”and not necessarily as “preferred”over other embodiments. Further definitions for terms may be set out herein; these may apply to prior and subsequent instances of those terms, as will be understood from a reading of the present description.

The following generally relates to robotic manipulators, and more specifically, to a system, method, and robotic assembly for weight measurement of a supported load.

Precise measurement of lifted loads on a robotic manipulator (such as an arm) can be a substantially difficult and complex challenge; generally requiring a tradeoff between overly complex designs and loss of accuracy.

A general approach for controlling movements of a robotic arm/manipulator is to add sensors for receiving movement feedback signals from the robotic arm. In some cases, this can also include controlling the amount of current or pneumatic pressure provided to actuators of the robotic arm. In some cases, measuring imposed forces on the robotic arm can generally be based on a calibration procedure. In an example, calibration can include: (1) creating a baseline profile of energy consumed to move and maintain a position of an unloaded arm; and (2) comparing the baseline profile with an on-going measurement of energy consumed for the robotic arm while in operation. The measurement of energy consumed is used to indicate an amount of load present. In such approaches, the energy used may include the amount of electrical current or the amount of pneumatic pressure required to move or maintain the positions of the actuators. For example, in a particular type of robotic arm, initially, in order to form a baseline profile, patterns of usage of electrical currents for maintaining the position of actuators can be measured for various positions of the arm. Once the baseline profile is established, similar patterns of usage can be measured for different lifted loads in different positions of the arm; for example, where loading and unloading is expected to happen. Generally, for calibration of robotic arms, the loads are typically within a specified pre-determined range. The calibration can then be used to estimate an unknown load on the robotic arm for various practical operations.

A substantial limitation of the above approach is that it requires access to internal components of a robotic arm; such as control systems, actuators, and sensors. Such requirements make it realistically impossible to use a ready-to-use robotic arms as a component of robotic systems. As a result, severe limitations are placed on the design of such systems whereby the whole arm with its controlling components have to be accessible, or the choices of ready-to-use robotic arms are very limited to models that allow full access to internal components of the robotic arm; imposing extra costs due to design complications.

Another general limitation of the above approaches is inaccuracy of measurements. Various parameters can render a baseline calibration to be substantially inaccurate; for example, errors accumulated during calibration, such as due to temperature of an operating environment, or other operational factors. Calibration of such systems can also be very complicated and may require specialized technicians to manually perform the calibration; and may also require substantial on-going maintenance or re-calibration.

Another approach for measuring a load is by installing sensors on a tip of a grabber or a loading assembly located at the end of the robotic arm. Such approaches limit the choice of sensors to a very limited range of force sensors that (1) can be fitted on the tip of the lifting assembly, and, at the same time, (2) can be protected from exposure to the loaded materials. For example, liquids or powdered materials may interfere with force sensors and can substantially harm the functioning of such sensors; potentially causing malfunctions.

In other approaches, a sensor assembly, made up of several sensors, may be used to act as a mechanical interface between the tip of a robotic arm and a grabber/lifter assembly.

Such sensor assemblies usually measure a combination of two forces: (1) the total weight of a grabber/lifter assembly and (2) lateral forces at the point of mechanical connections between the tip of a robotic arm and a grabber/lifter assembly. Any change in such forces can be monitored to determine an amount of change in the load. A substantial issue with such approaches is that the sensors will generally be under constant forces, potentially making the readings from the sensors be at the extremum of their design limits. In some cases, to address such issues, better sensors can be used at higher costs. However, even with better sensors, the substantially complicated calibration, described above, will still generally be required to determine the weight of lifted loads based on the combination of sensor readings.

Embodiments of the present disclosure advantageously provide a precise weight measurement assembly that can maintain contact between a grabber/lifter assembly and the tip of a robotic arm. The measurement assembly can rely on creating a balance of gravity on the grabber/lifter and it measures changes in the balance. Embodiments of the present disclosure advantageously use relatively simple components and non-complex combinations of components. Embodiments of the present disclosure advantageously also provide precise measurement using relatively simple sensors. Advantageously, the present embodiments generally allow for low cost of production and maintenance.

In an embodiment, a weight measurement assembly for a robotic arm comprises two interface plates, at least one hinge assembly disposed between the two interface plates, and a force measurement sensor. Persons skilled in the art will appreciate that additional components, a plurality of the above components, or other alternatives with similar capabilities or functions can be used.

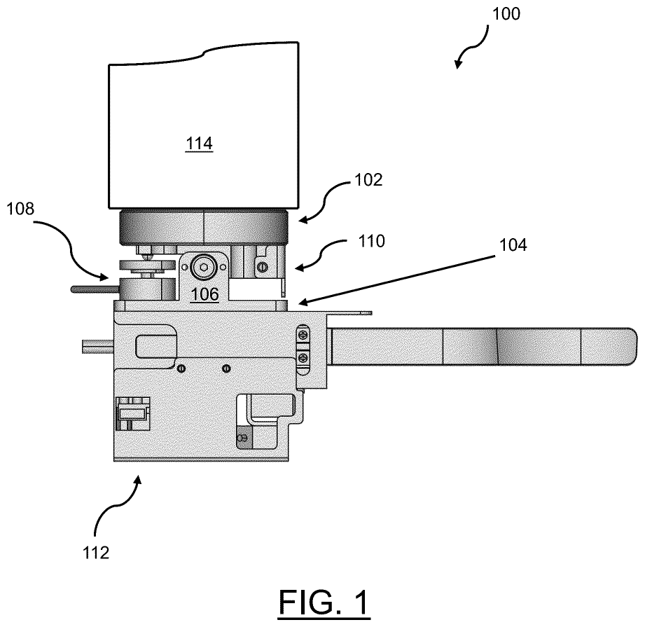

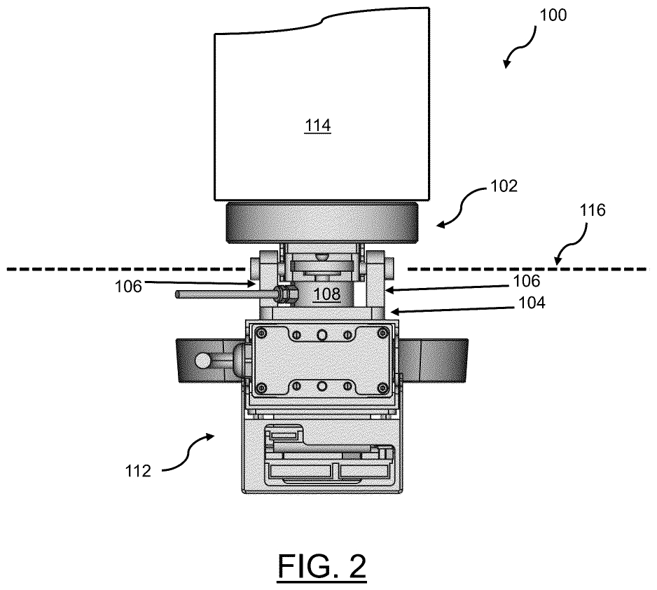

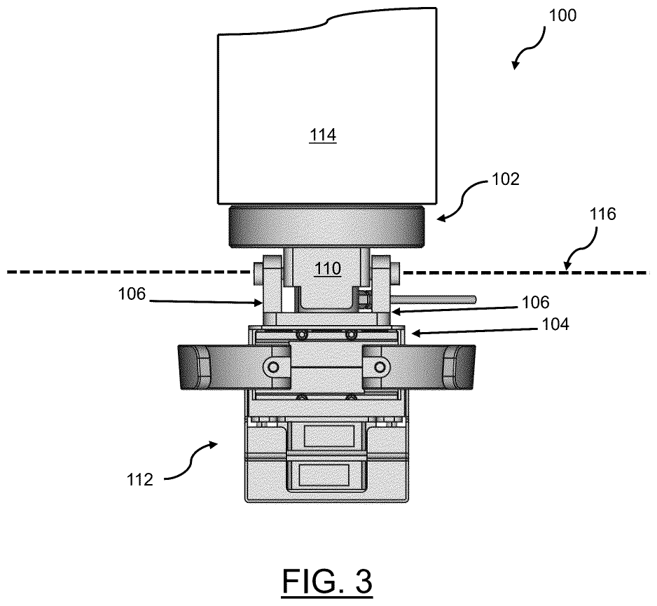

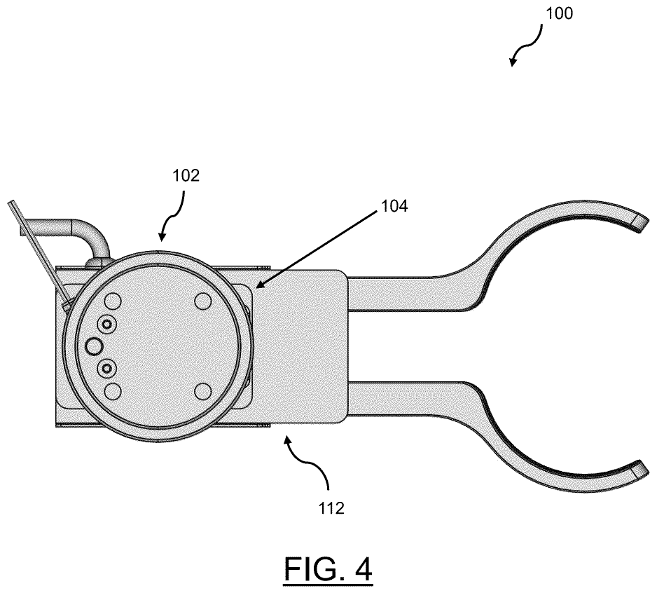

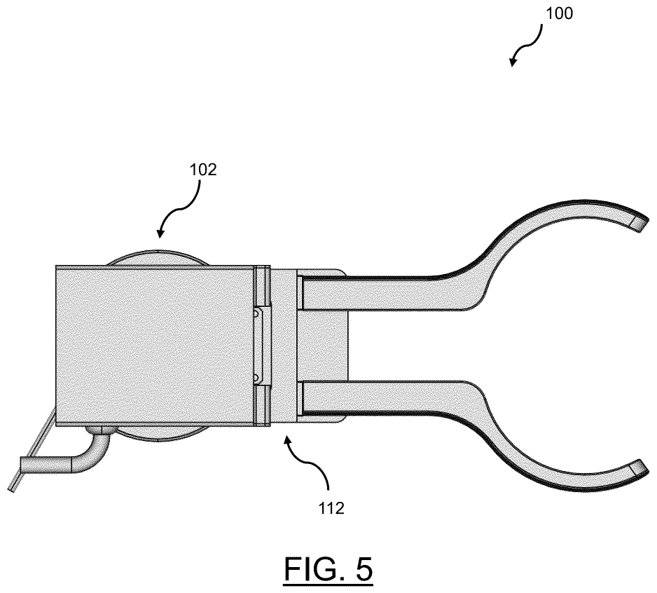

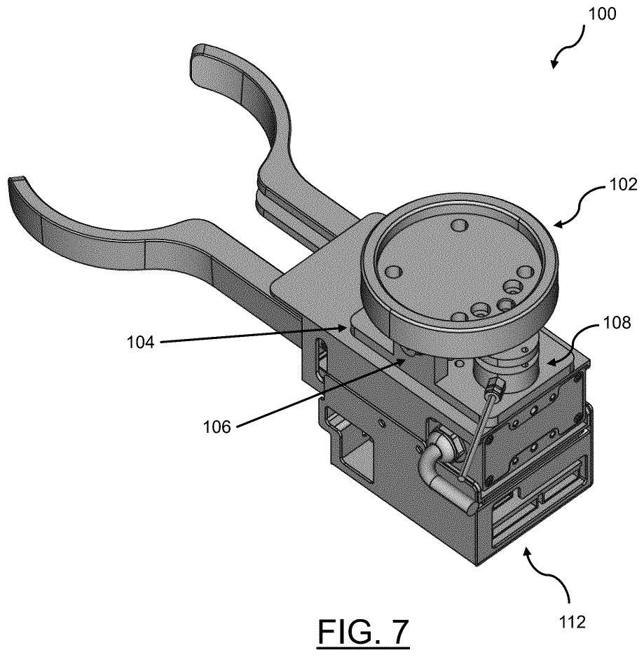

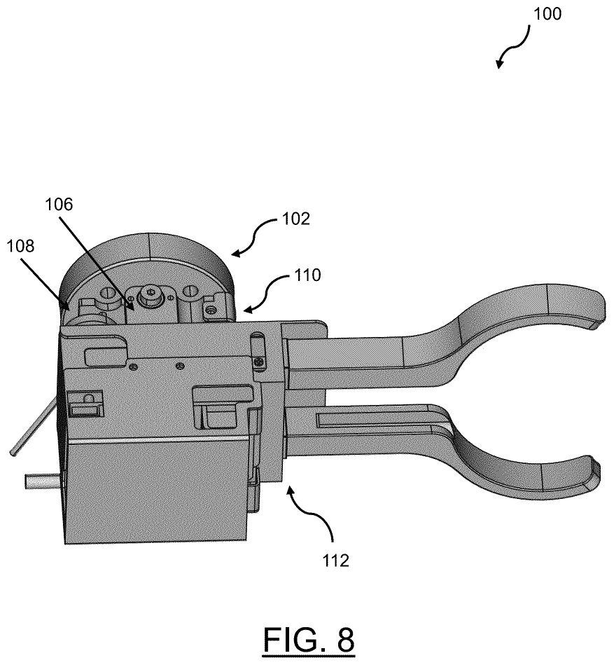

Referring to FIGS. 1 to 8, an embodiment of a weight measurement system 100 for a robotic arm is shown. In this embodiment, the system 100 includes an assembly-side interface plate 102, a load-side interface plate 104, hinge assemblies 106, a force sensor 108, and a movement limiter 110. The system 100 can be coupled to a load support 112 and a robotic arm 114, where the system 100 is located therebetween.

The assembly-side interface plate 102 is used to mount the precise weight measurement system 100 on the robotic arm 114. While the present disclosure generally describes use with a robotic arm, it is understood that any other robotic element, or any other assembly of interest that requires the added capability of precise measurement of the weight for loaded or lifted materials, can be used. The load-side interface plate 104 is used to mount the load support 112, or other assembly, to the system 100. The hinge assemblies 106 are disposed between the assembly-side interface plate 102 and the load-side interface plate 104. The tilting axis 116 of the plurality of the hinge assemblies 106 is aligned to allow a tilting movement of the load-side plate 102 in relation to the arm-side plate 104 around the tilting axis 116.

In a particular case, each of the two sides of the hinge assemblies 106 can be mounted, welded, or otherwise located on the assembly-side interface plate 102 or the load-side interface plate 104, respectively. Alternatively, at least one of the sides of the hinge assemblies 106, and the assembly-side interface plate 102 or the load-side interface plate 104, respectively, can be formed from a single piece of material.

In the present embodiment, as illustrated in FIG. 1, the force sensor 108 is located between the assembly-side interface plate 102 and the load-side interface plate 104, mounted on either the assembly-side interface plate 102 or the load-side interface plate 104. The force sensor 108 converts a physical force applied due to rotation of the load-side interface plate 104 relative to the assembly-side interface plate 102, as described herein, into an electrical signal that can be measured and analyzed. Any suitable type of force sensor can be used; for example, a capacitive load cell, a piezoelectric transducers, a strain gauge load cell or the like. The force sensor 108 can be located in front of, or behind, the tilting axis 116. Depending on the type of force sensor 108, a sensor gap, G_{S}, can be defined between the surface of the force sensor 108 and the assembly-side interface plate 102, where the force sensor 108 is located on the load-side interface plate 104; and vice versa where the force sensor 108 is located on the assembly-side interface plate 102.

The movement limiter 110 is located on the assembly-side interface plate 102, and positioned on the other side of the tilting axis 116 than the force sensor 108. The movement limiter 110 arresting further tilting motion after disengagement of the force sensor; for example, to avoid damage to the force sensor 108. A limiter gap, Gₗ, can be defined between an end of the movement limiter 110 and the load-side interface plate 104, where the movement limiter 110 is located on the assembly-side interface plate 102. Alternatively, the force sensor 108 can be located on the assembly-side interface plate 102, such that the sensor gap, G_{S}, is defined between the load-side interface plate 104 and the force sensor 108. In such a case, the movement limiter 110 can be located on the load-side interface plate 104 to form the limiter gap, Gₗ, between the assembly-side interface plate 102 and an end of the movement limiter 110. A person skilled in the art will appreciate that additional combinations and components can be added to allow and limit pivoting movement of the load-side interface plate 104 in relation to the assembly-side interface plate 102.

In some cases, the hinge assemblies 106 allow the load-side interface plate 104 a prescribed amount of degrees of angular rotation, CA, around the tilting axis 116 relative to the assembly-side interface plate 102; such as with the use of a spring or piston as the movement limiter 110.

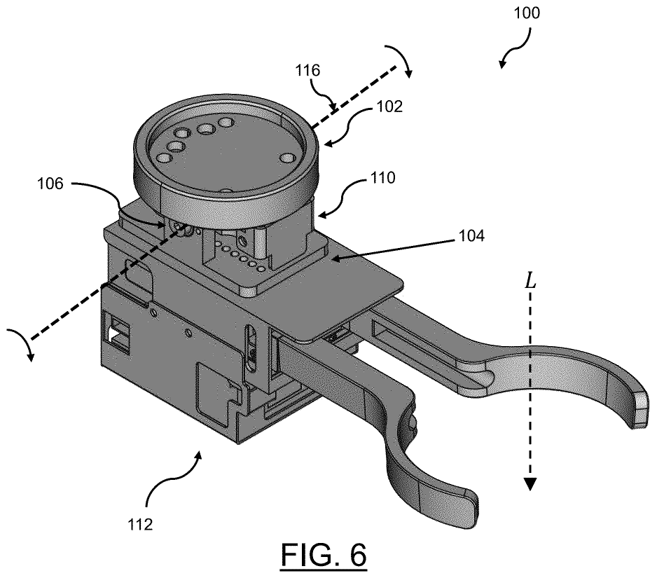

In some cases, a center of gravity of a combination of the load support 112 and the load-side interface plate 104 can be positioned along a common plane with the tilting axis 116 in order to maintain a desired distance for the gaps, Gₗ and G_{S}; and to form a stable balance such that the assembly-side interface plate and the load-side interface plate are substantially parallel with the load support is unloaded. The position of the tilting axis 116 means that adding a load, L, on the load support 112, as illustrated in FIG. 6, rotationally tilts both the load support 112 and the load-size plate 104 around the tilting axis 116 resulting a reduced, or zero, sensor gap, G_{S}. This rotation effectively transfers rotational forces provided by the load, L, to the force sensor 108.

In other cases, the position of the tilting axis 116 can be positioned off-to-the-side of the vertical plane that crosses the center of gravity formed by the combination of the load support 112, the load-side interface plate 104, and the hinge assemblies 106. In such cases, this offset in positioning can reduce the sensor gap, G_{S}, when compared to the above case where the combined center of gravity and the hinge axes 116 are located on the same plane. The amount of offset can be used to increase the limiter gap, Gₗ; such that the sensor gap, G_{S}, is reduced to zero and the force sensor 108 is always engaged.

The embodiment shown in FIGS. 1 to 8 includes the movement limiter 110 on the side of the system proximate to the supported load and the force sensor 108 on the side opposite the 32 supported load measuring extension forces on the force sensor 108. However, any suitable 33 arrangement can be used. In another embodiment, the force sensor 108 can be located on the side of the system 100 proximate the supported load, measuring compression forces on the force sensor 108. In such embodiments, the movement limiter 110 may be omitted by having the unloaded neutral position balanced such that the load-side interface plate 104 and the assembly-side interface plate 102 are approximately parallel. In further embodiments, the movement limiter 110 may be omitted by permitting the load-side interface plate 104 and the assembly-side interface plate 102 to come into contact in the most-tilted position.

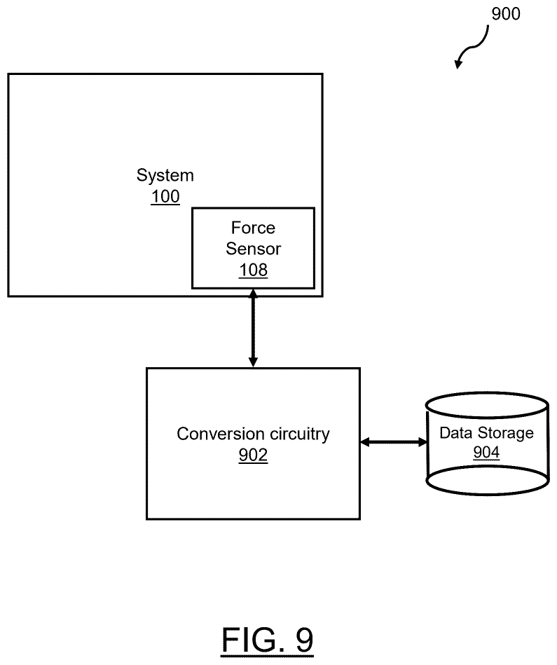

FIG. 9 shows various components of an embodiment of an operating environment 900 for the system 100. As shown, the force sensor 108, of the system 100, communicates with conversion circuitry 902. The conversion circuitry 902 can be, for example, general purpose processor(s), dedicated processor(s), microprocessor, microcontroller, field programmable gate array, other types of integrated circuits, or the like. In some cases, the conversion circuitry 902 can be in communication with a data storage 904 to store converted data, and in some cases, executable instructions.

The conversion circuitry 902 can be used to convert the electronic signals received from the force sensor 108 to force values. Generally such conversion can use a calibration to convert the electronic signals received from the force sensor 108 to force values. Such calibration can include, for example, applying a plurality of known forces to the system 100 and storing the associated values of the electronic signals received from the force sensor 108. However, any suitable calibration approach can be used; for example, comparing to a previously determined table of values.

Advantageously, the present embodiments permit determination of the weight of a load while minimizing potential damages to the force sensor 108. The structure of some of the present embodiments also advantageously ensures that the force sensor 108 is engaged when the load support 112 is loaded. Further advantageously, the position of the force sensor 108 keeps it away from the grabber and thus protects it from contamination from objects engaged by the load support 112; such as, from spillage of liquids, powdered materials, and other unwanted contaminants. Thus, increasing the overall durability of the sensor and maintaining its calibration configurations for a longer period of time.

In further embodiments, the components of the system 100 can be configured for a normally loaded configuration. In such configuration, the system 100 is in a neutral position when the load support 112 possess a load. The force sensor 108 will then provide measurements when such load is changed because the tilt of the load-side interface plate 104 relative to the assembly-side interface plate 102 will change accordingly.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A system for weight measurement of a supported load, the system comprising:
an assembly-side interface plate connectable to a robotic assembly;
a load-side interface plate connectable to a load support, the load support to receive a load;
hinge assemblies located intermediate the assembly-side interface plate and the load-side interface plate to permit tilting of the load-side interface plate relative to the assembly-side interface plate along a tilting axis; and
a force sensor located intermediate the assembly-side interface plate and the load-side interface plate on the assembly-side interface plate or the load-side interface plate, the force sensor located to a side of the tilting axis, the force sensor engageable to convert a force acting on the force sensor to an electrical signal when the load support supports the load.

2. The system of claim 1, the system further comprising a movement limiter located intermediate the assembly-side interface plate and the load-side interface plate on the assembly-side interface plate or the load-side interface plate, the movement limiter located to a side of the tilting axis opposite the force sensor, the movement limiter arresting further tilting after disengagement of the force sensor.

3. The system of claim 2, wherein the movement limiter defining a gap between an end of the movement limiter and the opposing assembly-side interface plate or the opposing load-side interface plate.

4. The system of claim 1, wherein the robotic assembly comprises a robotic arm.

5. The system of claim 1, wherein the load support comprises a grasping assembly.

6. The system of claim 1, wherein a combined center of gravity for the load support and the load-side interface plate is located along a common plane with the tilting axis such that the assembly-side interface plate and the load-side interface plate are substantially parallel with the load support is unloaded.

7. The system of claim 1, wherein the force sensor is located on a side of the tiling axis opposite the load support, and wherein the force sensor measures extension forces acting on the force sensor.

8. The system of claim 1, wherein the force sensor is located on a side of the tiling axis proximate the load support, and wherein the force sensor measures compression forces acting on the force sensor.

9. The system of claim 1, wherein the force sensor communicates with conversion circuitry to convert the electronic signal to a force measurement, the force measurement based on a calibration associating the electronic signal with a corresponding weight.

10. A robotic assembly comprising:
a robotic arm;
an assembly-side interface plate connectable to the robotic arm;
a load-side interface plate connectable to a load support, the load support comprising a grabber to grasp a load;
hinge assemblies located intermediate the assembly-side interface plate and the load-side interface plate to permit tilting of the load-side interface plate relative to the assembly-side interface plate along a tilting axis; and
a force sensor located intermediate the assembly-side interface plate and the load-side interface plate on the assembly-side interface plate or the load-side interface plate, the force sensor located to a side of the tilting axis, the force sensor engageable to convert a force acting on the force sensor to an electrical signal when the load support supports the load.

11. The robotic assembly of claim 10, the robotic assembly further comprising a movement limiter located intermediate the assembly-side interface plate and the load-side interface plate on the assembly-side interface plate or the load-side interface plate, the movement limiter located to a side of the tilting axis opposite the force sensor, the movement limiter arresting further tilting after disengagement of the force sensor.

12. The robotic assembly of claim 11, wherein the movement limiter defining a gap between an end of the movement limiter and the opposing assembly-side interface plate or the opposing load-side interface plate.

13. The robotic assembly of claim 10, wherein the robotic assembly comprises a robotic arm.

14. The robotic assembly of claim 10, wherein a combined center of gravity for the load support and the load-side interface plate is located along a common plane with the tilting axis such that the assembly-side interface plate and the load-side interface plate are substantially parallel with the load support is unloaded.

15. The robotic assembly of claim 10, wherein the force sensor is located on a side of the tiling axis opposite the load support, and wherein the force sensor measures extension forces acting on the force sensor.

16. The robotic assembly of claim 10, wherein the force sensor is located on a side of the tiling axis proximate the load support, and wherein the force sensor measures compression forces acting on the force sensor.

17. The robotic assembly of claim 10, wherein the force sensor communicates with conversion circuitry to convert the electronic signal to a force measurement, the force measurement based on a calibration associating the electronic signal with a corresponding weight.
